(19) United States
(12) Patent Application Publication
(10) Pub. No.: US 2016/0113246 A1
(43) Pub. Date: Apr. 28, 2016

(54) NOISE CANCELATION FOR PIEZOELECTRIC SENSOR RECORDINGS

(71) Applicants: Kevin D. Donohue, Lexington, KY (US); Bruce F. O'Hara, Lexington, KY (US)

(72) Inventors: Kevin D. Donohue, Lexington, KY (US); Bruce F. O'Hara, Lexington, KY (US)

(21) Appl. No.: 14/523,994

(22) Filed: Oct. 27, 2014

(51) Int. Cl. A01K 29/00; G01L 25/00

(52) U.S. Cl. CPC A01K 29/005; G01L 25/00

(57) ABSTRACT

Detecting and classifying rodent movement and/or motion includes sensing a first signal from a first sensor indicative of motion of a first rodent, wherein the first signal includes a first noise component and sensing a noise reference signal from a second sensor indicative of ambient noise. Next, modifying the first signal based on the noise reference signal to produce a first output signal, wherein said first output signal includes a second noise component less than the first noise component; and then outputting the first output signal.

### BACKGROUND

The present invention relates generally to monitoring rodents and, more particularly, to tracking rodent behavior in high throughput systems.

Invasive techniques for qualifying animal behavior as either sleeping or awake are known such as Electroencephalographic (EEG) and Electromyographic (EMG) recordings. However, the surgery, surgery recovery, and signal scoring, among a number of other factors, limit their application to relatively small-scale studies.

Non-invasively tracking rodent behavior in high throughput systems typically used in research laboratories with mice can include a number of difficulties as well. One challenge is to maintain reasonable costs that allow scaling up to multiple units while also maintaining reasonable accuracy. As an example, a non-invasive high throughput system for automatically detecting characteristic behaviors in mice over extended periods of time can be helpful for phenotyping experiments. A conventional tracking system can, for example, classify time intervals on the order of two to four seconds as corresponding to motions consistent with activity associated with an animal being awake or with inactivity associated with the animal sleeping.

One typical sensor for detection movement is a single Polyvinylidine Difluoride (PVDF) sensor on a cage floor that generates electrical signals in response to pressure caused by movement of an animal. One difficulty with PVDF sensors is that they tend to be susceptible to noise from external sources such as electromagnetic interference (EMI), electro static noises from nearby moving bodies, light, and ambient vibrations. This susceptibility to noise can adversely impact a sensor's accuracy for detecting animal behaviors tied to low level signals such as those that result from sleeping, resting, REM sleep, NREM sleep, breath rates, etc.

### SUMMARY

Embodiments of the present invention relate to a method for detecting and classifying rodent movement and/or motion includes sensing a first signal from a first sensor indicative of motion of a first rodent, wherein the first signal includes a first noise component and sensing a noise reference signal from a second sensor indicative of ambient noise. Next, modifying the first signal based on the noise reference signal to produce a first output signal, wherein said first output signal includes a second noise component less than the first noise component; and then outputting the first output signal

A system for detecting rodent movement that includes a first sensor configured to sense a first signal indicative of motion of a first rodent, wherein the first signal includes a first noise component; and a second sensor configured to sense a noise reference signal indicative of ambient noise. The system also includes a signal mixer configured to modify the first signal based on the noise reference signal to produce a first output signal, wherein said first output signal includes a second noise component less than the first noise component; and a signal transmitter configured to output the first output signal.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of the present invention are illustrated by way of example, and not by way of limitation, in the accompanying drawings, wherein:

FIG. 1 depicts a block-level diagram of an animal sensing system in accordance with the principles of the present invention.

FIG. 2A depicts a block level diagram of acquiring sensor signals in accordance with the principles of the present invention.

FIG. 2B depicts a flowchart of an exemplary method for performing noise cancellation in accordance with the principles of the present invention.

FIG. 3 depicts details of an exemplary noise cancellation algorithm in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In the description below, reference is made to a PVDF sensor by way of example only and one of ordinary skill will recognize that other functionally equivalent sensors can be used without departing from the scope of the present invention.

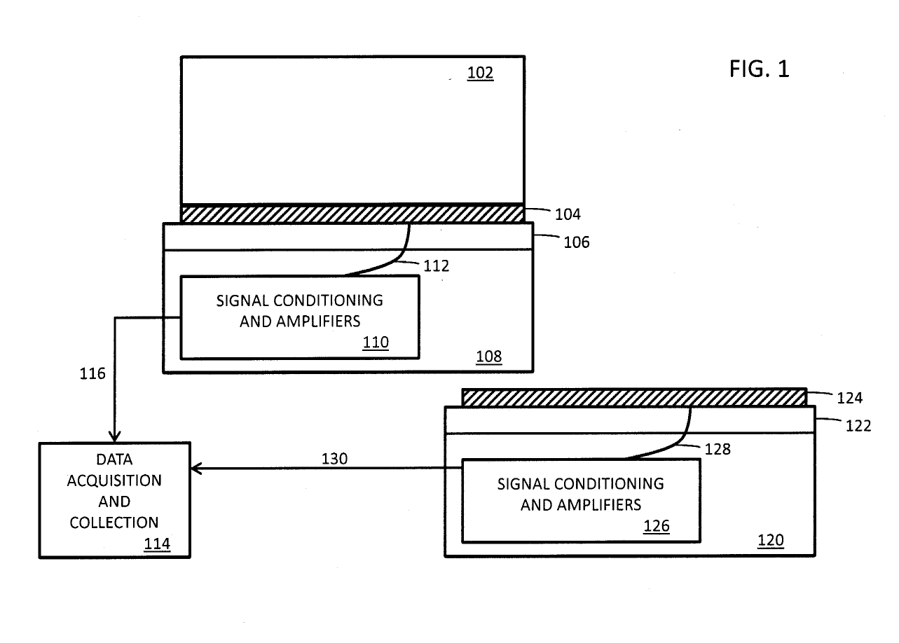

FIG. 1 depicts a block-level diagram of an animal sensing system in accordance with the principles of the present invention. At the most general level, the system 100 includes a cage 102 for a rodent, for example, that has a sensor 104 for detecting motion of the rodent such as a PVDF sensor. There is also a second, similar sensor 124 which is nearby but isolated from the sensor 104. As explained below, the signals from the sensor 104 and from the sensor 124 can be combined in such a way as to improve the accuracy of sensing motion of the rodent. The term “nearby” can vary in meaning but is intended to encompass an area of proximity wherein the sensor 104 and 124 are exposed to substantially similar ambient conditions (e.g., light, electrical fields, vibration, noise, etc.).

The cage 102 can have a floor to which the sensor 104 is coupled with such that rodent-caused vibrations within the cage 102 transmitted to the sensor 104. The cage 102 and the sensor 104 can rest on a base 108 as well. In addition, a rubber pad, or isolation pad 106, can be located between the sensor 104 and the base 108. The base 108 can be sized and constructed such that electronic circuitry such as signal filters and amplifiers 110 can be located therein. This circuitry 110 can be connected to the sensor 104.

In the above-described environment, a rodent in the cage 102 will move (e.g., through breathing, or walking, or grooming, or sleeping) and cause the sensor 104 to generate a signal indicative of the motion of the rodent. This signal is then communicated through the connection 112, which can be a wired or wireless connection, to the amplifier circuitry 110. The resulting amplified signal 116 can then be communicated to a data acquisition and collection system 114.

The sensor signal (and amplified signal 116) may, however, have unwanted noise components that are not due to the motion of the rodent. For example, electrodes on the sensor 104 may pick up 60 Hz and other noises with aliased harmonics through electric fields. Nearby motion of other objects or individuals can create capacitive coupling within the sensor that results in low frequency transient noise. Also, ambient room vibrations can be coupled to the sensor 104 through the cage 102 and base 108.

Accordingly, in accordance with the principles of the present invention, a second, separate sensor 124 is arranged similar to the sensor 104. The sensor 124 lays over an isolation pad 122 on a base 120 that houses a second set of amplifier circuitry 126. The sensor 124 and amplifiers 126 communicate over a link 128. A separate signal 130 produced by the second set of amplifier circuitry 126 is communicated to the data acquisition and collection system 114. A difference between the sensor 104 and the sensor 124 is that the sensor 124 is not placed in a way such that it is coupled with a rodent's cage to sense motion of that rodent. However, the signal produced by the sensor 124 should still have noise components similar to those sensed by the sensor 104 but should not have components intentionally related to motion of a rodent.

The two sensors 104, 124 are shown separately in FIG. 1 to indicate that they are two separate sensors. However, they could both be attached to the cage 102 as long as the sensor 124 is not directly sensing motion of a rodent. For example, one common rodent cage is, in fact, four distinct cages arranged on a single base 108. Each such cage would have its own separate sensor 104 but a single isolation pad 106 may still be utilized. In such a setup, three of the four cages could be occupied (and thus each have a respective sensor 104) while one cage could be unoccupied (and, thus, have a sensor 124). This location would ensure the sensor 124 is exposed to similar noise-causing phenomena as the rodent sensors 104.

One of ordinary skill will recognize that there are a variety of different ways to locate the sensor 124 near the other sensors 104 without departing from the scope of the present invention. Each cage could have a sensor 104 and sensor 124 or each four-cage unit could have one sensor 124 and four sensors 104. However, fewer of the sensors 124 can be used as well. For example, a table that supports tens or dozens of the four-cage units could have one sensor 124 to generate a noise signal that can be used in relation to all of those cages on that table which each have a separate sensor 104 sensing rodent motion. In a lab in which there are multiple tables, each table could have its own sensor 124 or a single sensor 124, preferably located centrally in the room, could be used for the entire room.

In the example environment of FIG. 1, the following specific example is provided to aid with understanding underlying principles of the present disclosure. These specific details are but one example of how signals related to the motion of rodents can be accurately obtained.

The PVDF sensor 104, 124 can be sized such that it has a slightly large footprint than the floor of the cage 102. One example PVDF sensor can be 17.78 cm by 17.78 cm square and have a dielectric with a thickness of about 110 μm. The sensor 104 can be covered by a protective sheet (not shown) and bedding for the animal (not shown) can be placed on the protective sheet.

In an example environment in which the cage 102 is actually multiple cages such that there are a number of sensors near one another, the isolation pad 106 can be used to reduce cross-talk between the different sensors. The pad 106 can, for example, be about 1.6 mm thick, constructed from Shore A 70 Durometer silicon, and extend substantially over the entire top of the base 108 underneath one or more sensors 104.

An example capacitance of the PVDF sensor sheet 104 is approximately 30 nF and when coupled to an input differential amplifier, followed by a low-pass filter, effectively band-pass filters the pressure signals with 3 dB down points at 1.35 Hz and 20 Hz. The differential amplifier provides a high pass effect and can, for example, have a linear gain of about 22. The amplified signals can be fed to a multi-channel data acquisition board (e.g., National Instruments PCI 6224), sampled at 128 samples per second, and quantized with 16 bits.

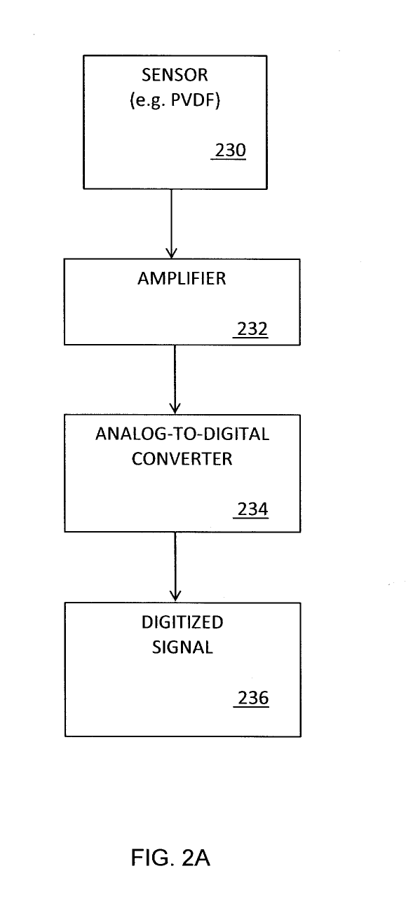

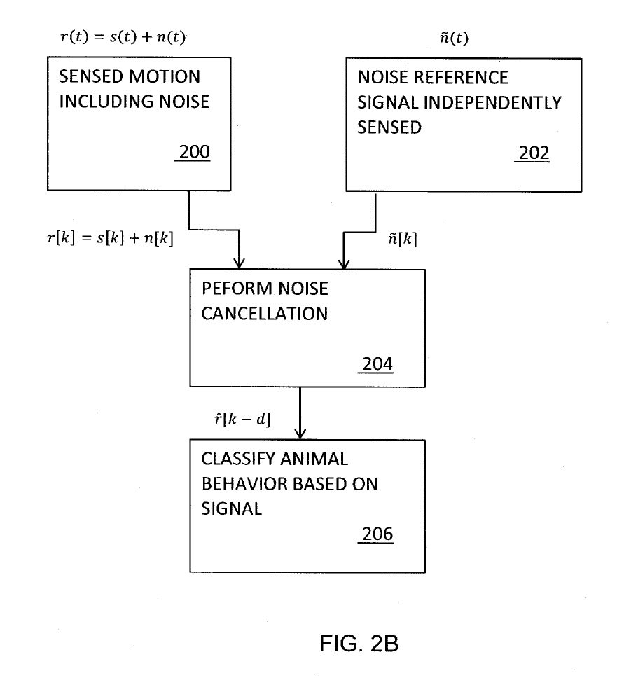

FIG. 2A depicts a block level diagram of acquiring sensor signals in accordance with the principles of the present invention. A sensor 230 (which can be either the sensor 104 or 124 of FIG. 1) generates electrical, analog signals that are communicated to an amplifier 232. These amplified signals can then be digitized. For example, an analog-to-digital converter 234 can be used to quantize the analog signal into a sampled digital signal 236. One of ordinary skill will recognize that the amplification level (i.e., gain) of the amplifier 232 and the sampling rate of the A-to-D converter 234 can vary without departing from the scope of the present invention.

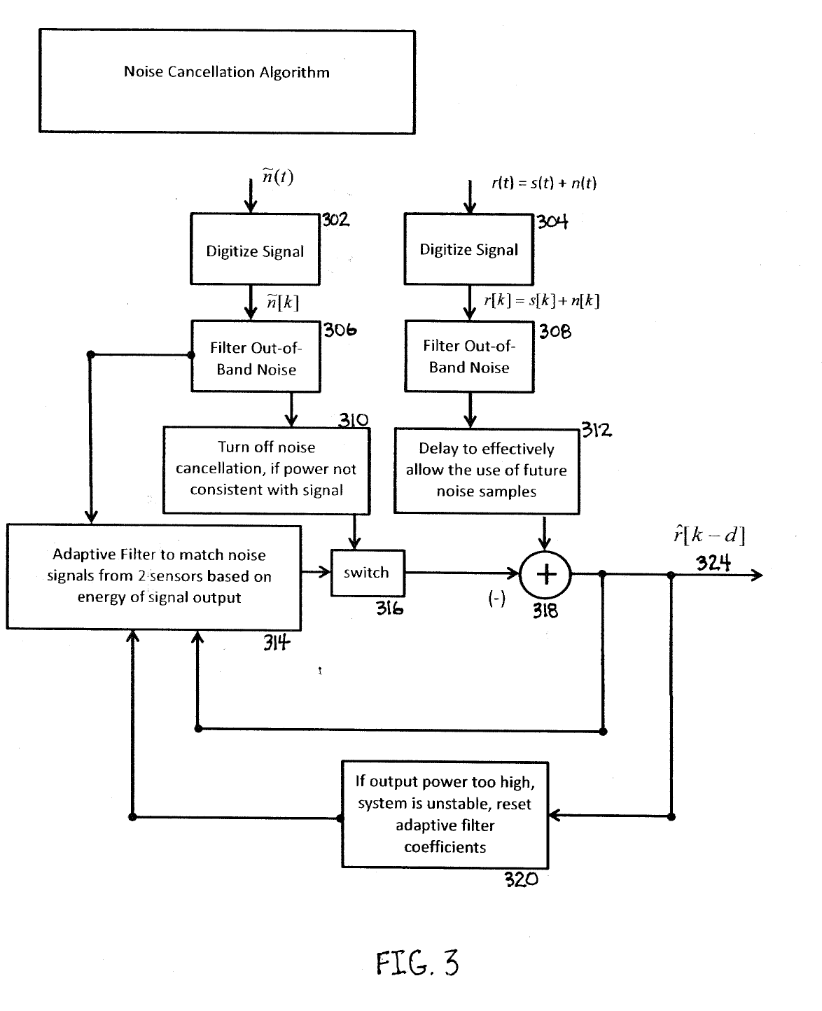

FIG. 2B depicts a flowchart of an exemplary method for performing noise cancellation in accordance with the principles of the present invention. The data acquisition and collection system 114 can implement a noise cancellation algorithm in accordance with the principles of the present invention. The algorithm can be executable instruction stored on a computer or processor that, when executed, perform the steps depicted in FIG. 2B and FIG. 3.

The signal r(t)=s(t)+n(t) in FIG. 2B is sensed and amplified, in step 200, and includes a component s(t) related to rodent movement and some component n(t) related to unwanted noise. This signal, r(t), as mentioned above can be digitized into signal r[k]=s[k]+n[k]. Separately, using a nearby sensor, ñ(t) is sensed. in step 202, and represents a noise refrence signal that provides some insight into the characteristics of n(t). This signal is also digitized to produce signal ñ[k]. Next, in step 204, a noise cancellation algorithm is implemented to produce a signal \hat{r}[k−d]. This signal has a delay d, which can be zero, such that a current sample (i.e. [k−d]) of \hat{r}[k−d] relies, in part on, “future” noise reference samples ñ[k].

Although an example noise cancellation technique is described herein with respect to FIG. 3, one of ordinary skill will recognize that, generally, the noise cancellation step 204 combines the signals ñ[k] and r[k] in such a way as to reduce the effect n[k] has on the signal \hat{r}[k−d]. This final signal is what is analyzed in step 206 to classify the current behavior of a rodent. By compensating for the noise that may be present in the environment, improvements can be made to a sensor's accuracy for detecting animal behaviors tied to low level signals such as those that result from sleeping, resting, REM sleep, NREM sleep, breath rates, etc. One of ordinary skill in this field will recognize that signal signatures are known that indicate a rodent is awake and breathing normal, is REM sleeping or is non-REM sleeping. The quantized, sampled, and delayed signal with reduced noise \hat{r}[k−d] can now be analyzed to classify these types of behavior events of a rodent within a cage.

FIG. 3 depicts details of an exemplary noise cancellation algorithm in accordance with the principles of the present invention. Similar to the steps discussed earlier with respect to FIG. 2B, the digitized signals ñ[k] and \hat{r}[k−d] are generated from sensor signals in steps 302 and 304, respectively. In steps 306, 308 each of the signals can be filtered in a similar manner. For example, a band-pass filter could range from about 1 to 20 Hz or from about 0.5 Hz to 25 Hz. In one particular beneficial use related to sleep/awake monitoring, a filter associated with the amplifier circuitry can low pass filter from about 18 Hz and, then, the data acquisition and collection software/hardware can band pass filter from between 0.5 Hz to about 8 Hz.

The filtered noise reference signal is passed to an adaptive filter in step 314. In step 312, a determination is made if the reference noise signal is of sufficient power to be considered a noise signal that can be used for noise cancellation. If the reference noise signal is not useful, then a switch 316 can be set to block any noise cancellation signal generated by the adaptive filter. If the reference noise signal is useful then the switch 316 is set to pass the output of the adaptive filter to the combiner at step 318.

Returning now to the right-hand side of FIG. 3, the filtered, digitized rodent sensor signal is delayed, in step 312, by a number of samples, d, before being combined with the noise cancellation signals from the adaptive filter. For example, with a LMS filter, the filter can have a filter of order 32 and a delay of 16 samples (that is at a 128 Hz sampling rate) that corresponds to a delay of about 0.128 seconds. Usually orders between 30 and 60 work well with delays ranging from 0.1 to 0.5 seconds. Thus, the delayed rodent sensor signal is combined in step 318 with the output of the adaptive filer (depending on the state of the switch 316) to produce a noise-cancelled signal \hat{r}[k−d] 324. This signal 324 includes a component that is related to movement or motion of a rodent in a cage and may still also include a noise component. However, the noise component in this latter signal 324 is far less than the original noise component n(t) due to the noise cancellation steps.

As shown in FIG. 3, the adaptive filter is fed both the reference noise signal and the output signal 324 in order to produce the values used to cancel noise in the rodent sensor signal r(t) (or, r[k]). One particular class of adaptive filters that is beneficial for step 314 is known as least mean squares filters.

Least mean squares (LMS) algorithms are a class of adaptive filter used to mimic a desired filter by finding the filter coefficients that produce a desired outcome. The basic idea behind LMS filter is to approach the optimum filter weights by updating the filter weights in a manner to converge to the optimum filter weight. In particular, as shown in FIG. 3. the filter can be adaptive to minimize the output power with a model of the noise. Assuming the noise and signal are for the most part independent (orthogonal), an optimal fitting of a noise signal to the data will minimize power and leave the signal intact. In other words the filter coefficients are adjustable to minimize output power.

Accordingly, the algorithm of FIG. 3 includes step 320 which determines if the quantized, sampled, and delayed signal with reduced noise \hat{r}[k−d] has an output power that is over a predetermined threshold value. If so, then a determination is made that the system may be unstable and the adaptive filter coefficients are reset.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for detecting rodent movement, comprising:
sensing a first signal from a first sensor indicative of motion of a first rodent, wherein the first signal includes a first noise component;
sensing a noise reference signal from a second sensor indicative of ambient noise;
modifying, by a computer, the first signal based on the noise reference signal to produce a first output signal, wherein said first output signal includes a second noise component less than the first noise component; and
outputting the first output signal.

2. The method of claim 1, wherein sensing a first signal comprises:
sensing an analog signal;
amplifying the analog signal to generate an amplified signal; and
analog-to-digital converting the amplified signal to generate the first signal.

3. The method of claim 1, wherein:
the first sensor is physically coupled with an enclosure of the first rodent; and
the second sensor is located proximate to the first sensor.

4. The method of claim 1, comprising:
sensing a third signal from a third sensor indicative of motion of a second rodent, wherein the third signal includes a third noise component;
modifying, by a computer, the third signal based on the noise reference signal to produce a second output signal, wherein said second output signal includes a fourth noise component less than the third noise component; and
outputting the third output signal.

5. The method of claim 1, comprising:
determining if a power level of the noise reference signal is above a predetermined threshold; and
only when the power level of the noise reference signal is above the predetermined threshold, modifying the first signal based on the noise reference signal to produce the first output signal.

6. The method of claim 1, wherein modifying comprises:
providing the noise reference to an adaptive filter;
providing the first output signal to the adaptive filter;
calculating, using the adaptive filter; a noise cancellation value; and
modifying the first signal based on the noise cancellation value to produce the first output signal.

7. The method of claim 6, comprising:
determining if a power level of the first output signal is above a predetermined threshold; and
when the power level of the first output signal is above the predetermined threshold, resetting filter coefficients of the adaptive filter.

8. The method of claim 7, wherein the adaptive file implements a least mean square algorithm.

9. The method of claim 1, wherein the first sensor and the second sensor are each a PVDF pad.

10. The method of claim 1, comprising:
classifying a behavior event of the rodent based on the first output signal.

11. A system for detecting rodent movement, comprising:
a first sensor configured to sense a first signal indicative of motion of a first rodent, wherein the first signal includes a first noise component;
a second sensor configured to sense a noise reference signal indicative of ambient noise;
a signal mixer configured to modify the first signal based on the noise reference signal to produce a first output signal, wherein said first output signal includes a second noise component less than the first noise component; and
a signal transmitter configured to output the first output signal.

12. The system of claim 11, comprising:
an input configured to detect an analog signal;
an amplifier configured to amplify the analog signal to generate an amplified signal; and
an analog-to-digital converter configured to digitize the amplified signal to generate the first signal.

13. The system of claim 11, wherein:
the first sensor is physically coupled with an enclosure of the first rodent; and
the second sensor is located proximate to the first sensor.

14. The system of claim 11, comprising:
a third sensor configured to sense a third signal indicative of motion of a second rodent, wherein the third signal includes a third noise component;
the signal mixer configured to modify the third signal based on the noise reference signal to produce a second output signal, wherein said second output signal includes a fourth noise component less than the third noise component; and
a signal transmitter configured to output the third output signal.

15. The system of claim 11, comprising:
a signal analyzer configured to determine if a power level of the noise reference signal is above a predetermined threshold; and
a switch selectable between two positions based on whether the power level of the noise reference signal is above the predetermined threshold.

16. The system of claim 11, wherein the signal mixer comprises an adaptive filter that includes:
a first input configured to receive the noise reference to an adaptive filter;
a second input configured to receive the first output signal to the adaptive filter;
a set of filter coefficients for calculating a noise cancellation value; and
an output configured to communicate the first output signal to the signal mixer.

17. The system of claim 16, comprising:
a signal analyzer configured to determine if a power level of the first output signal is above a predetermined threshold; and
when the power level of the first output signal is above the predetermined threshold, the adaptive filter resets its filter coefficients.

18. The system of claim 17, wherein the adaptive file implements a least mean square algorithm.

19. The system of claim 11, wherein the first sensor and the second sensor are each a PVDF pad.

20. The system of claim 11, comprising:
a signal analyzer configured to classify a behavior event of the rodent based on the first output signal.
